(19) United States
(12) Patent Application Publication
(10) Pub. No.: US 2019/0266881 A1
(43) Pub. Date: Aug. 29, 2019

(54) SYSTEM AND METHOD FOR AN ALERT AND CRISIS/EMERGENCY MANAGEMENT SYSTEM

(71) Applicant: LAURA GASPARIS VONFROLIO, Staten Island, NY (US)

(72) Inventor: LAURA GASPARIS VONFROLIO, Staten Island, NY (US)

(21) Appl. No.: 16/229,106

(22) Filed: Dec. 21, 2018

Related U.S. Application Data
(60) Provisional application No. 62/634,910, filed on Feb. 25, 2018.

(51) Int. Cl. G08B 25/01; H04N 7/18; H04W 4/90

(52) U.S. Cl. CPC G08B 25/016; H04W 4/90; H04N 7/185

(57) ABSTRACT

A System, method, and apparatus providing in-band and out-of-band notification of a crisis/emergency event from an initiation point to a distributed network via event alerting and communications. The method includes the establishment of an augmented full and/or half-duplex streamed content being communicated with crisis/emergency management services personnel and potentially at least one additional authorized individual.

### CROSS-REFERENCE TO RELATED APPLICATIONS

This patent application claims priority to U.S. Provisional Patent Application No. 62/634,910, filed Feb. 25, 2018, the entire contents of which are hereby incorporated by reference.

### FIGURE SELECTED FOR PUBLICATION

FIG. 3

### BACKGROUND OF THE INVENTION

### Field of the Invention

The present invention relates to a mobile/wearable Personal Alert Device and a Crisis/Emergency Management System. More particularly, the present invention relates to methods, apparatuses, and systems for mobile and wearable emergency communication devices and the integration with crisis/emergency management communication interconnect technology employing both packet-switched and traditional telephone networking technologies.

Additionally, the present invention relates to mobile/wearable technology used for communicating important information during crisis/emergency situations amongst educators, first responders, and other authorized personnel. More particularly, the present invention describes methods, systems, and apparatus for the rapid establishment of communications channels between authorized individuals/services and educational personnel in near proximity to a crisis situation.

### Description of the Related Art

Various forms of communication technologies have been used for sending information and alerting other interested parties dating back to ancient times. In the 1950's the US government developed a nationwide emergency alerting system (established in 1951, President Harry S. Truman) as CONELRAD (Control of Electromagnetic Radiation) was a method of emergency broadcasting to the public of the United States in the event of enemy attack during the Cold War. It was intended to allow continuous broadcast of civil defense information to the public using radio stations, while rapidly switching the transmitter stations to make the broadcasts unsuitable for Soviet bombers to home in on the signals.

Over the next decades, CONELRAD was replaced by the Emergency Broadcast System (EBS) on Aug. 5, 1963, which was later replaced by the Emergency Alert System (EAS) on Jan. 1, 1997; all have been administered by the Federal Communications Commission (FCC). Given the advancements in technology since the turn of the millennium, the President of the United States can now directly send a broadcast “Presidential Alert” text message to more than 250 million active cellphones in the US and abroad.

In the 1980's, personal medical alert devices became commercially available from a number of organizations such as Life Alert®. These devices became highly popularized. These wearable radio transmitters allowed an individual to gain rapid access to communications with trained dispatch personnel. Specifically, these services were designed to appeal particularly to seniors who might experience a medical emergency and be unable to reach the telephone.

Emergency Mass Notification Systems (EMNS) are commercially available today from a number of different companies. See for example, the description in U.S. Pat. No. 8,736,443 (Miasnik, et al) and US Pat. Pub. No. 2011/0111728A1 (Ferguson, et al).

Unfortunately, these improvements are efforts to allow organizations to centralize emergency/incident reporting and notification capabilities. Referring now to FIG. 1, is an illustrative example of an architecture for a generic EMNS system as developed by the AtHoc® Corporation. FIG. 1 depicts a plurality of input devices to communicate with a state of the art unified notification service (EMNS) to report crisis event information. The reported information is then processed by the EMNS system/personnel, and notifications are then potentially communicated to a plethora of recipient devices.

FIG. 2 is an embodiment of a conventional voice communications system developed by the Vocera Corporation for hospital and clinical environments. FIG. 2 depicts an architecture arrangement utilizing special smart phones and voice enabled badge devices that are interconnected over an organization's data network to the Vocera® system services that enable “in-facility” communications to a mobile workforce (i.e. nurse, doctors, clinicians, housekeeping, administrative, other staff members, etc.).

Unfortunately, generic EMNS and voice communication systems, are complex to install, manage, and use, and require rigid controls and are incapable of determining a location of an event or the end of an event. The operational complexity is difficult to manage by non-technical individuals responsible for safety.

In educational facilities in the US infrastructures are often non-modern (old-construction) and are maintained by a non-technical and non-trained staff. As a result, an educator experiencing an emergency event in a classroom may trigger notice to a central building office via a wired intercom or a wire phone-relay system only. Further problematic, in order to reach a wired intercom or wired phone-relay system, the educator may need to abandon an individual in need, or otherwise fail to timely confront a problem or fail to quickly reach outside assistance. Additionally, assuming that an “in-building” system is operational and the information arrives at the educational central office, it is then the responsibility of the administrative personnel to (further steps) contact the crisis/emergency service(s).

Alternatively, the educator could use their personal cellular phone device to directly dial emergency services while simultaneously attempting to address the situation at hand. A number of difficulties may ensue.

### ASPECTS AND SUMMARY OF THE PRESENT INVENTION

The present invention provides systems and methods for a a system and method for an alert and crisis/emergency management system shown as a teacher alert system wherein a system, method, and apparatus provides in-band and out-of-band notification of a crisis/emergency event from an initiation point to a distributed network via event alerting and communications. The method includes the establishment of an augmented full and/or half-duplex streamed content being communicated with crisis/emergency management services personnel and potentially at least one additional authorized individual.

According to another alternative aspect of the present invention provides systems and methods for crisis and/or emergency management system.

According to another alternative aspect of the present invention there is provided an improvement to access emergency/crisis management and notification services, to reduce the complexity and total cost of ownership of these systems, to maintaining compatibility with existing emergency service infrastructure, to operate over packet-switched and traditional telephone networking technologies, to involve prerecorded information such as textual or audio indications of the type of event that is occurring (e.g., active shooter, terrorist attack, medical emergency, etc.), prerecorded location information (school, building, floor, room number, area, etc.) if within the confines of a, compound, facility, or campus, floor plans/map of the facility and/or area, derived location information (GNSS information, network based location information, etc.), an identification of known individual(s) in proximity of the event, any sensor information available (velocity, direction, moisture, temperature, pressure, heart rate, presence of toxic substances, etc.) as well as any audio or visual information to arequested crisis/emergency management service (fire, ambulance, police, etc.) and/or other authorized individuals. This additional salient information about the event being provided to the crisis/emergency management service(s) and/or other authorized personnel, can help facilitate a more rapid and appropriate response to an event that is occurring, augmenting any human interaction.

According to another alternative aspect of the present invention provides systems and methods for a teacher personal alert device.

According to another alternative aspect of the present invention provides systems and methods for a crisis/emergency intermediary service.

According to another alternative aspect of the present invention provides systems and methods for a communications aggregation device for integration with crisis/emergency management services.

According to another alternative aspect of the present invention provides for systems and methods integrating of at least one teacher personal alert device, at least one communications aggregation device, and at least one crisis/emergency management service.

According to another alternative aspect of the present invention provides for systems and methods enabling communications and/or information sharing between at least one crisis/emergency manage service and at least one teacher personal alert device via at least one crisis/emergency management intermediary service.

According to another alternative aspect of the present invention provides for systems and methods enabling communications and/or information sharing between at least one crisis/emergency manage service, at least one teacher personal alert device, and at least one authorized individual via at least one crisis/emergency management intermediary service.

According to another alternative aspect of the present invention provides for systems and methods for enabling communications via wireless communication hardware and protocols between at least one teach personal alert device and one communications aggregation device.

According to another alternative aspect of the present invention provides for systems and methods for the at least one aggregation communications device to be operatively coupled to sensor technology for capturing information including, but not limited to: Velocity, Direction, Moisture, Temperature, Pressure, Heart rate, Presence of toxic substances, Audio, and Video.

According to another alternative aspect of the present invention provides for systems and methods for the at least teacher personal alert device to be operatively coupled to sensor technology for capturing information including, but not limited to: Velocity, Direction, Moisture, Temperature, Pressure, Heart rate, Presence of toxic substances, Audio, Video,

According to another alternative aspect of the present invention, there is provided a wireless remote system providing teachers, first responders, and other interlinked personnel, with information regarding an event via one of a plurality of alternative wireless communication protocols via a hardware and software system interlinking wireless remotely enabled components through multiple component information protocols.

According to another alternative aspect of the present invention there is provided a teacher alert system including a personal alert device, a base station, and enabled Internet cloud-located based service, system monitoring interface, and responder call systems in an integrated and operational system.

According to another alternative aspect of the present invention, there is provided a teacher alert system wherein one or more personal assert devices each being an Internet-of-Things (IoT) operable communication link, and at least one IoT operable base station in an operable communication link with an IoT operable system monitoring interface, responder call system, and cloud-located storage components.

It is to be understood that both the foregoing general description and the following detailed description are exemplary and explanatory only, and are not restrictive of the invention as claimed. The accompanying drawings constitute a part of the specification, illustrate certain embodiments of the invention, and together with the detailed description, serve to explain the principles of the invention.

### BRIEF DESCRIPTION OF THE DRAWINGS

The invention can be more fully understood by reading the following detailed description together with the accompanying drawings, in which like reference indicators are used to designate like elements, and in which:

FIG. 1 is a schematic system block diagram of a conventional commercially available universal notification system as is known in the art from the AtHoc® Corporation.

FIG. 2 is a schematic system block diagram of a conventional commercially available “in-facility” voice/messaging communications system with wearable components as is known in the art from the Vocera® Corporation.

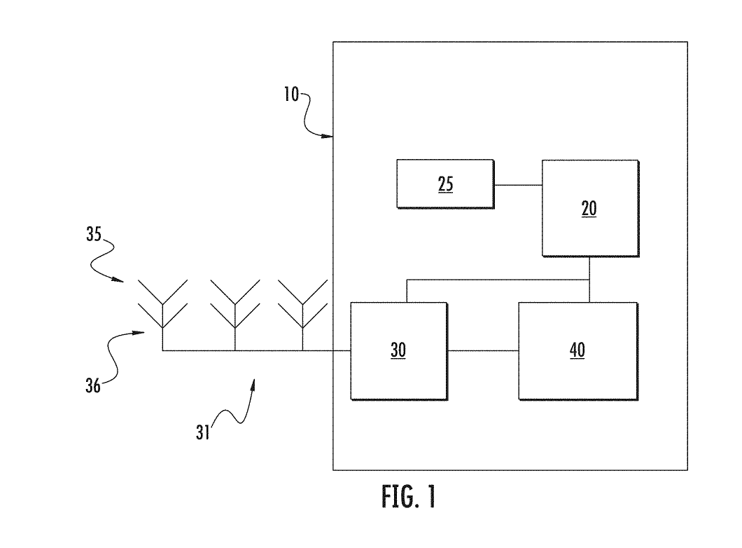

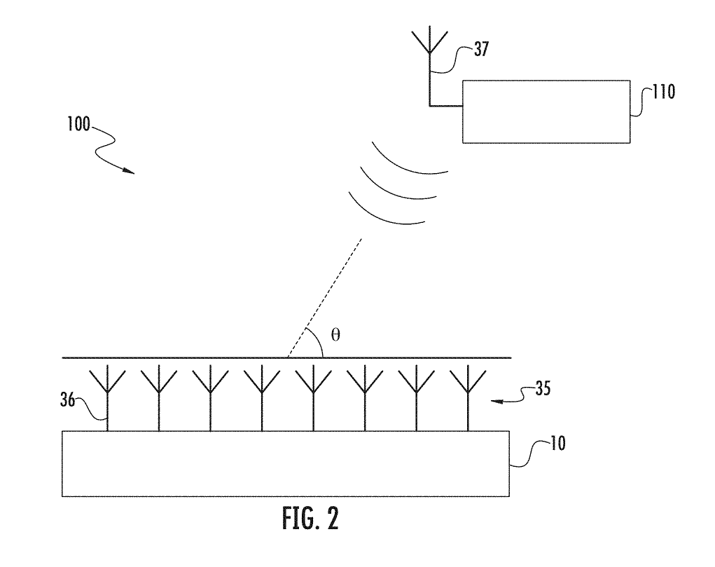

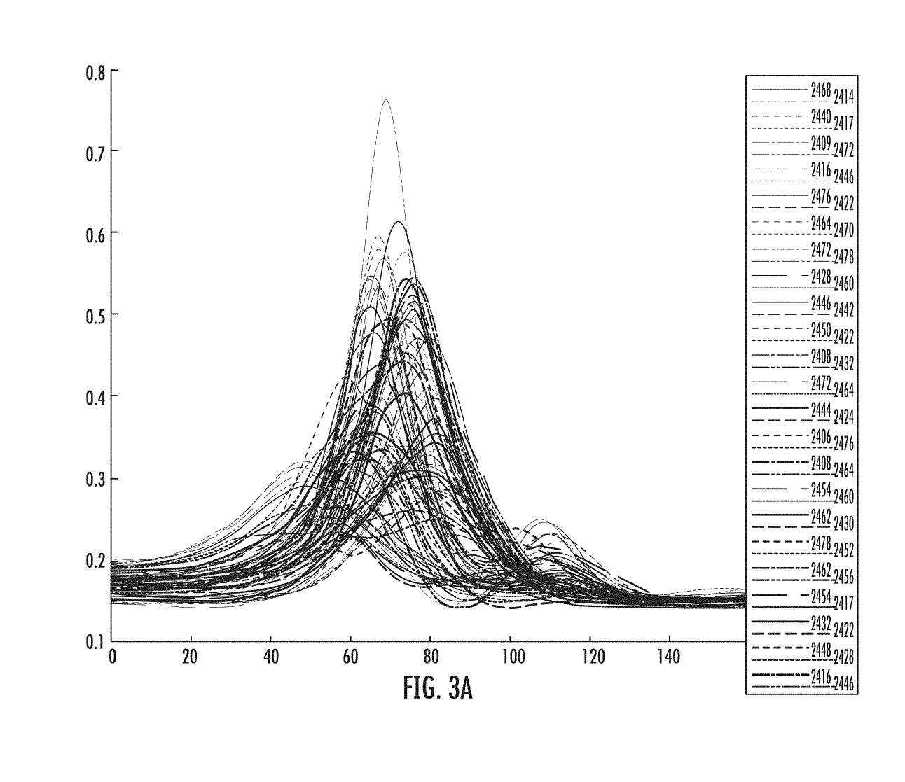

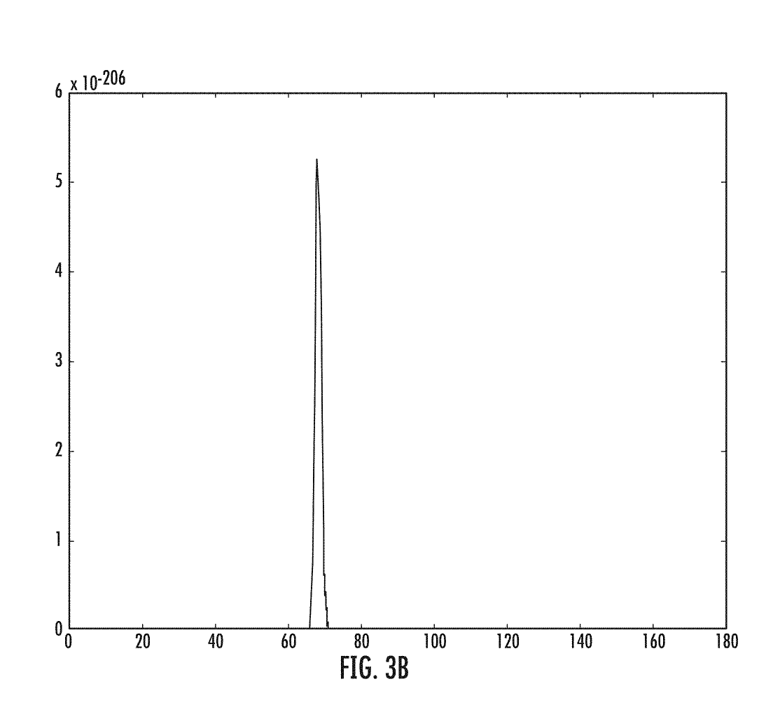

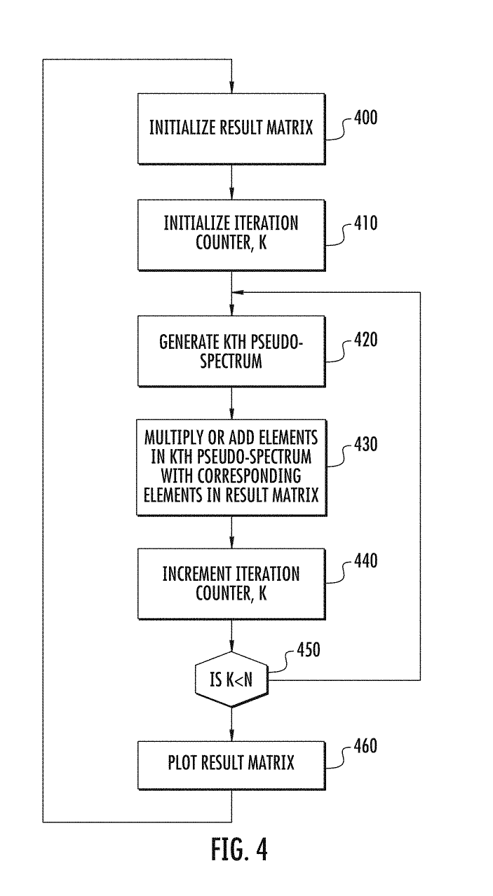

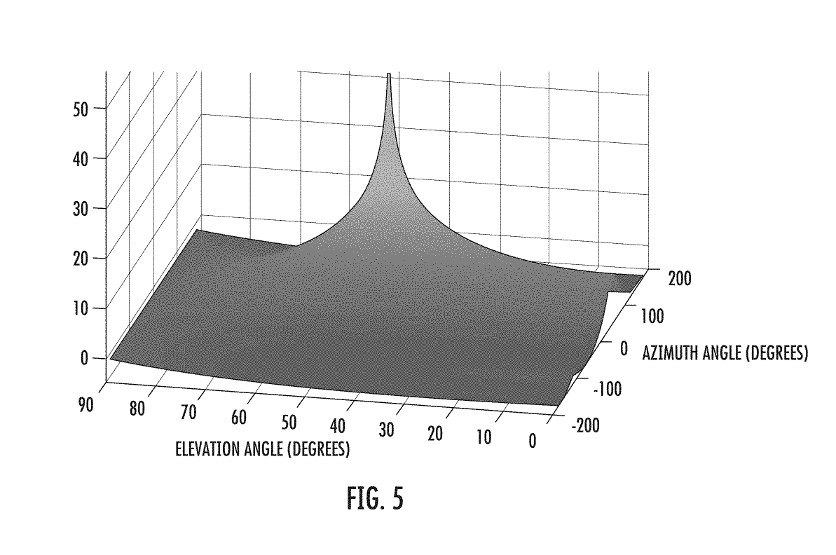

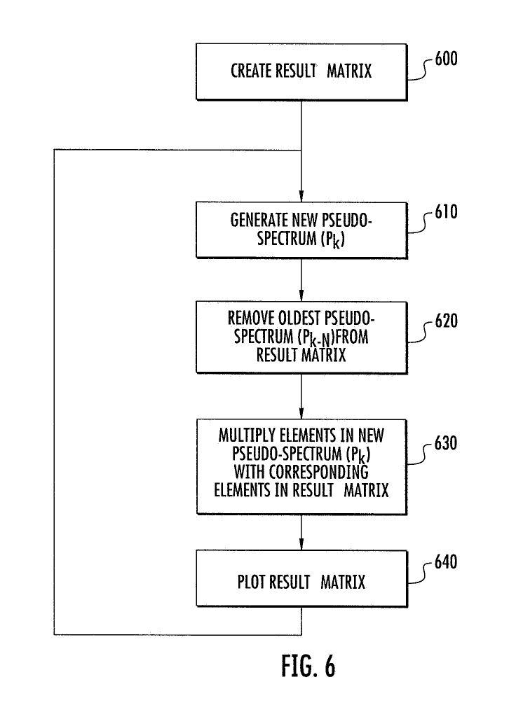

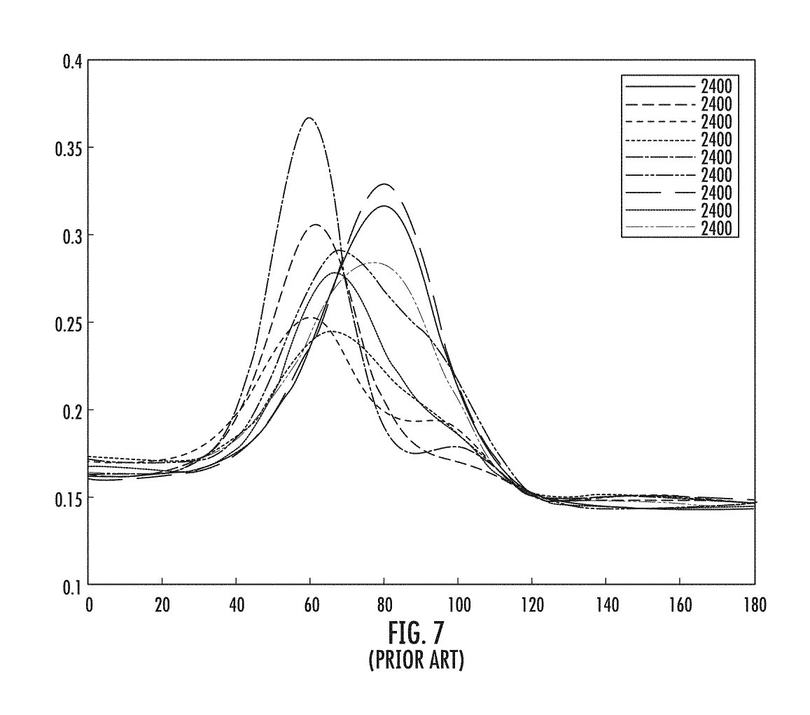

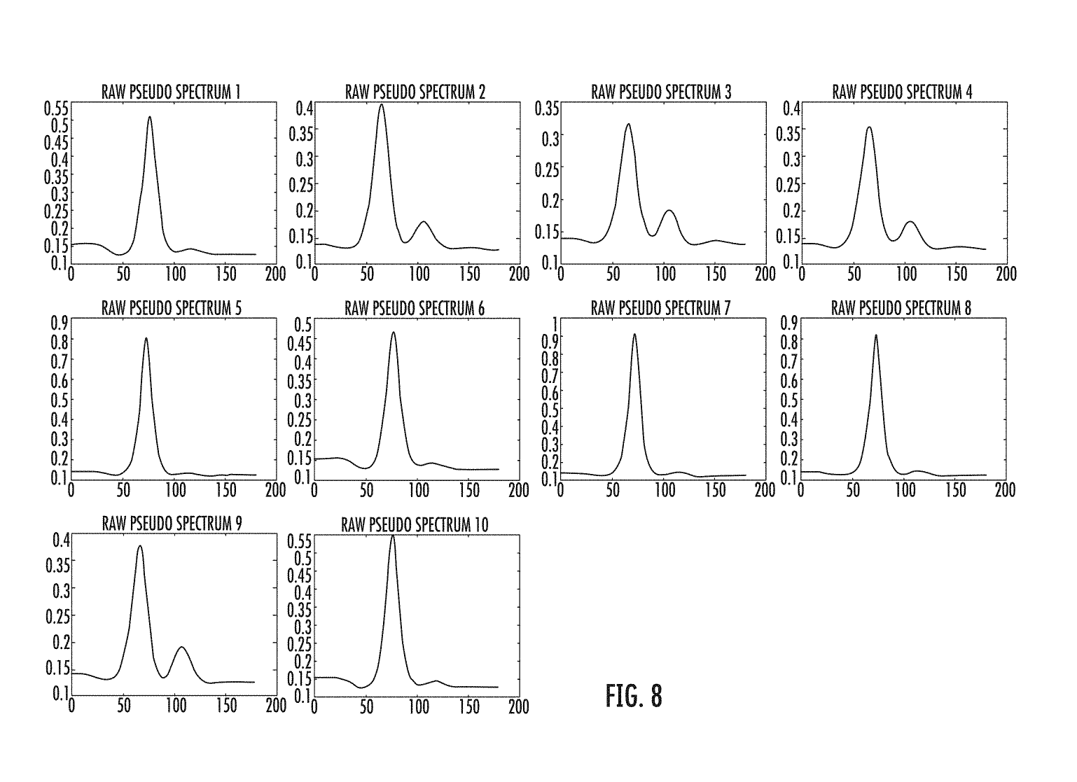

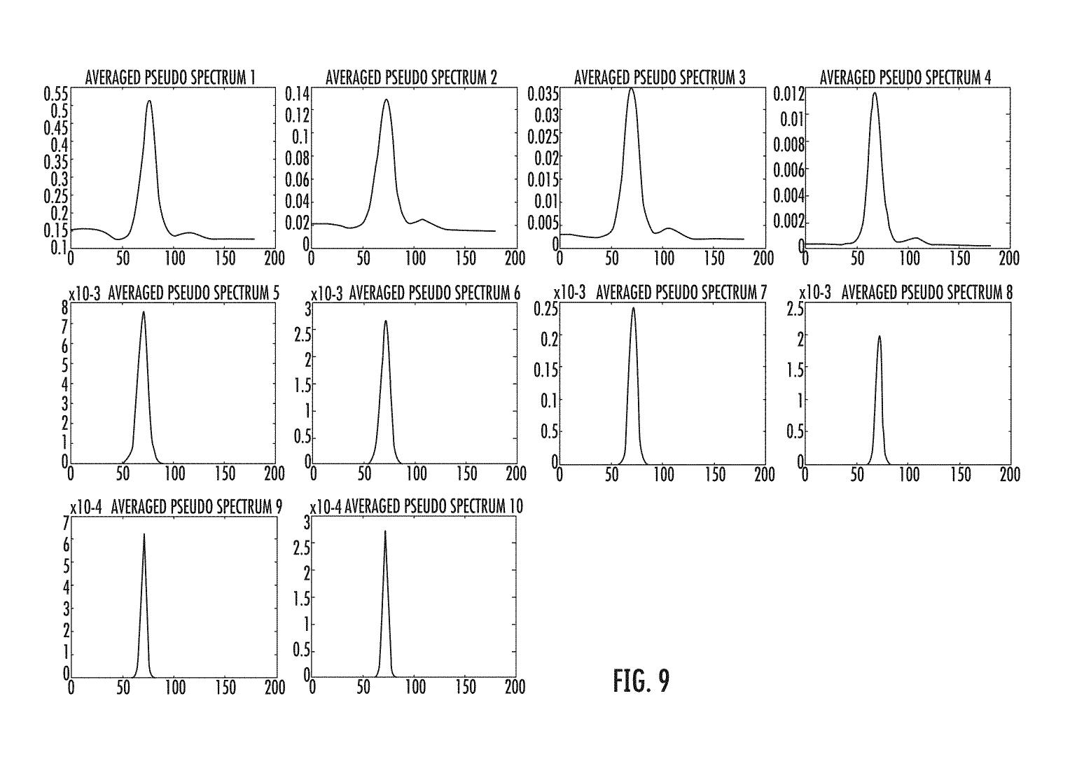

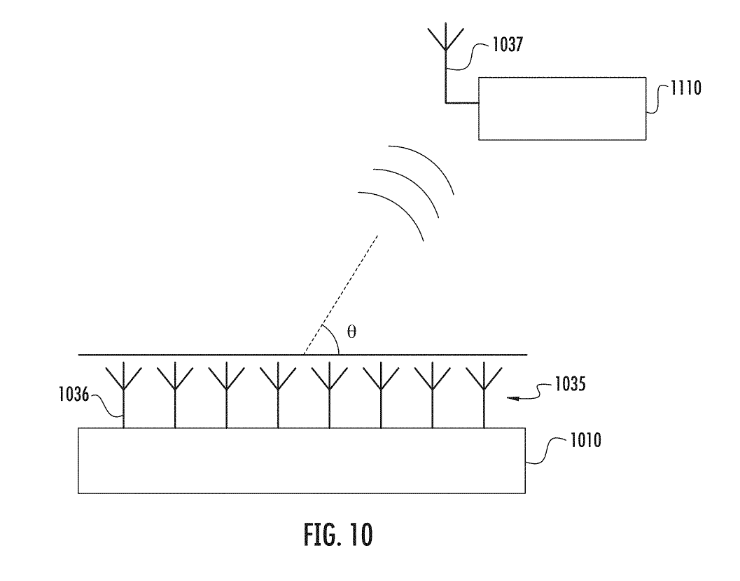

FIG. 3 is a schematic diagram depicting the teacher alert system according to an embodiment of the present invention.

FIG. 4 is a schematic diagram depicting the teacher personal alert device according to an embodiment of the present invention.

FIG. 5 is a schematic diagram depicting the teacher alert base station according to an embodiment of the present invention.

FIG. 6 is a schematic diagram depicting the teacher alert system services according to an embodiment of the present invention.

### DETAILED DESCRIPTION OF THE PREFERRED EMBODIMENTS

Certain embodiments of the present invention and their advantages may be better understood by referring to FIGS. 3-6, wherein like reference indicators refer to like elements, and are describe in the context of a teacher alert system. The word ‘couple’ and similar terms do not necessarily denote direct and immediate connections, but also include connections through intermediate elements or devices. For purposes of convenience and clarity only, directional (up/down, etc.) or motional (forward/back, etc.) terms may be used with respect to the drawings. These and similar directional terms should not be construed to limit the scope in any manner.

It will also be understood that other embodiments may be utilized without departing from the scope of the present invention, and that the detailed description is not to be taken in a limiting sense, and that elements may be differently positioned, or otherwise noted as in the appended claims without requirements of the written description being required thereto. Various operations may be described as multiple discrete operations in turn, in a manner that may be helpful in understanding embodiments of the present invention; however, the order of description should not be construed to imply that these operations are order dependent.

As used herein, an ‘computer-based system’ includes one or more input device for receiving data, one or more output device for outputting data in tangible form (e.g. signal transmission, signal generation, tone relay, print-actuation, displaying on a computer screen), a memory for storing data as well as related computer code, and one or more microprocessors for executing computer software code causing actuation of the microprocessor and an outputting of one or more outputs via said output device.

It will be further understood by those of skill in the art that the apparatus and devices and the elements herein, without limitation, and including the sub components such as operational structures, circuits, communication pathways, and related elements, control elements of all kinds, display circuits and display systems and elements, any necessary driving elements, inputs, sensors, detectors, memory elements, processors and any combinations of these structures etc. as will be understood by those of skill in the art as also being identified as or capable of operating the systems and devices and subcomponents noted herein and structures that accomplish the functions without restrictive language or label requirements since those of skill in the art are well versed in related communication technologies, cellular and wireless and RF-type communication protocols as well as any related operational controls and technologies of emergency responder systems, dispatch systems, and school-system administration system and all their related operational sub components, including various circuits and combinations of circuits without departing from the scope and spirit of the present invention. Nevertheless, the present invention is applicable to alternative embodiments and alternate communication technologies that includes at least one communications interface that is at least one of wireless, wired, continual, intermittent, verbose, compact, periodic, non-periodic, digital, analog, one-way, bidirectional, single-mode, multi-mode, optical, radio, any combination thereof.

Embodiments of the present invention may be implemented in hardware, software, firmware, or combinations thereof.

Embodiments of the present invention may also be deployed in multiple devices.

It will be readily understood by those persons skilled in the art that the present invention is susceptible to broad utility and application. Many embodiments and adaptations of the present invention other than those herein described, as well as many variations, modifications and equivalent arrangements, will be apparent from or reasonably suggested by the present invention and foregoing description thereof, without departing from the substance or scope of the invention.

While the foregoing illustrates and describes exemplary embodiments of this invention, it is to be understood that the invention is not limited to the construction disclosed herein. The invention can be embodied in other specific forms without departing from its spirit or essential attributes.

Referring now to FIG. 3, it depicts an exemplary non-limiting illustrative block diagram of the Teacher Alert System architecture (300). Considering the aforementioned information, for the sake of brevity and clarity the following exemplary description will enumerate the flow of information between educator (301) or an alternative personnel (not shown), using a single Teacher Personal Alert Device (310), located in facilities (330, 340, 350, 360), via Teacher Alert Base Stations (370, 371, 372, 373) that is coupled to the Internet and/or the Public Switched Telephone Network (PSTN), and the at least one Crisis/Emergency Management Service (390, 392, 394, 396). In no event is this enumeration to be interpreted as limiting as multiple Teacher Personal Alert Devices (310) may be operational at the same time. Similarly, a single Teacher Alert Base Station (371) may be operatively serving more than one Teacher Personal Alert Device simultaneously. Additionally, the Teacher Alert System Services (382) may also be employed depending on the needs of a particular clientele. More intricate arrangements of these components can be easily envisioned by those schooled in the art.

As depicted in FIG. 3, educator (301) or potentially alternative personal (bus driver, chaperone, janitor, administrator, safety officer, etc.—not shown) is associated with device (310), a Teacher Personal Alert Device (PAD). In this illustrative embodiment, the PAD device (310) is purpose built for the specific deployment, however it is to be understood that, alternative embodiments can be easily envisioned to operate as an application running on a smart handheld device (SHD) such as a smartphone, other personal mobile devices, etc. The PAD device (310) in this illustrative embodiment is a priori configured with information about the associated individual. Information, such as, but not limited to:
Who the individual (301) is
Organization the individual (301) is associated with (school, association, company, etc.)
Individual's (301) authority and responsibility (educator, group leader, etc.)
Information about any other individuals that individual (301) might be responsible for (a manifest of students, etc.)
Special needs of the other individuals that individual (301) is responsible for (medical conditions, pharmaceutical requirements, etc.)
Any special training or credentials that individual (301) may have (CPR, medical, military, concealed carry permit, etc.)
   The PAD device (310) may be also configured to be only associated with a single Teacher Alert Base Station (TABS—370) or enabled to associate with additional TABS units (371, 372, 373), potentially based on the proximity of the PAD device (310) to them. For instance in one illustrative embodiment, if the PAD device (310) was provisioned to a bus driver (not shown) of school bus (330), the PAD device (310) may be configured to only associate with TABS device (370). In one exemplary embodiment, if PAD device (310) becomes disconnected from TABS device (370) during certain operating hours, an indication of such a condition may be forwarded to an administrator responsible for the individual associated with PAD device (310).

However in another exemplary embodiment, if the PAD device (310) was provisioned to educator (301), whose responsibilities require them to move within and externally to an organization's facilities, based on policy, PAD device (310) may be allowed to establish communications with TABS device (370) associated with school bus (330), TABS device (371) associated with a school building (340) such as in a cafeteria or auditorium, TABS device (372) associated with a stadium on the campus of the school or elsewhere (350), and/or TABS device (373) associated with classroom facility (360).

As depicted in the non-limiting illustrative embodiment of FIG. 3, PAD device (310) wirelessly communicate with TABS devices (370, 371, 372, 373), allowing PAD device (310) to be mobile. Depending on which TABS device (370, 371, 372, 373) PAD device (310) is operatively communicating with, additional proximity information may be able to be provide regarding the location of PAD device (310).

Provided, below is a an operational source code portion from the PAD device that handles buttons detection. In the logic of the switch statement, there are three cases: 1^{st} case BtnActionGetIo, 2^{nd} case BtnActionUp, and 3^{rd} case BtnActionDown.

The BtnActionGetIo code when executed gets the current state of the button—either down or up. When this case is called, the value of myBtn->value is updated to the current state of the button. Now, based on this state information that was just stored in myBtn->value, the user interface software logic calls one of the other cases. If the button is determined to be in the up state, this routine is then called to execute the BtnActionUp code. What this code does is that it first formats a message buffer containing the template text “Button1 Up”. The next line of code then modified the 7th character in that string (counting from zero, that would be offset 6). If you count 7 characters in, you will notice that its the number of the button, in the template text its the ASCII value for the number “1” (one). The next line of code:

msgBuf[6]=‘0’+swIndex;

overwrites the one “1” character with the correct ASCII displayable button number. This logic works because the developer knows that adding a value between 0 & 9 (i.e. the number of the button that changed its state) to the ASCII symbol ‘0’ (zero) will yield a displayable/human readable number from 0 through 9. This message is then sent over the Bluetooth Serial Port Profile connection to the base station. Similarly, the code block (case BtnActionDown) operates the same way if the button was detected to be in the press state.

<<<< TAS PAD Button Detect Software Logic Source Code Snipit
Block >>>>>

switch (action)
{
case BtnActionGetIo:
// reset the data
myBtn−>value = GPIO_GetPin(swPtr);
// set the argument to boolean value
myBtn−>pressed = !myBtn−>value;
break;
case BtnActionUp:
// we just were released
if (myBtn−>count == 1)
{

memcpy(msgBuf, “Button1 Up”, 10);
msgBuf[6] = ‘0’ + swIndex;
BTAPP_SendDataOverSPP(msgBuf, 10);

}
break;
case BtnActionDown:
// we just were pressed
if (myBtn−>count == 1)
{

memcpy(msgBuf, “Button1 Down”, 12);
msgBuf[6] = ‘0’ + swIndex;
BTAPP_SendDataOverSPP(msgBuf, 12);

}
break;
default:
break;
}
<<<<<<<<<<<< End of Source Code Snippet >>>>>>>>>>

As depicted in an illustrative non-limiting embodiment, TABS devices (370, 371, 372, 373) may be operatively coupled to the Internet, and/or the PSTN via terrestrial or extraterrestrial base communications mediums suitable for voice and/or data communications. Furthermore, depending on the environment that TABS devices (370, 371, 372, and 373) are deployed, the TABS devices may be operatively coupled to one another. For instance in one illustrative embodiment, access to an Internet and/or PTSN network interconnect may only be available within the confines of facility (340). In this environment, TABS device (372) may wireless communicate with TABS device (371) to form a meshed network environment, providing Internet and/or PSTN network access to TABS device (372) via TABS device (371). Given this fact, its possible that TABS devices (370, 371, 372, 373) can be mobile themselves, availing themselves of any available or provisioned data/voice communication network interface such as, but not limited to: Fixed and or mobile wireless terrestrial technologies and protocols (Cellular, LTE, NB-IoT, LoRa, WIFI, Bluetooth, Satellite, Microwave, etc.), and Optical, waveguide, or other terrestrial communication medium technologies and protocols (Fiber, Ethernet, Dialup, etc.). The collective TABS device (370, 371, 372, 373) participating in a meshed network environment would then determine at least one route to operatively couple and direct communications traffic from PAD device (310) to the Internet/PSTN network services (380). For redundancy purposes, multiple TABS devices (370, 371, 372, 373) may be simultaneously connected to the Internet and/or the PSTN. TABS devices (370, 371, 372, 373) may also be placed to have overlapping coverage footprints to ensure there is consistent access through out a facility or area.

In another alternative embodiment, wherein a TABS device is mobile itself, as in the case of TABS device (370) that is stationed on school bus (330), the TABS device may also act as a PAD device (310). In another similar exemplary embodiment, instead of the TABS device (370) being purpose built for a specific deployment (e.g. NEMA4/IP65 enclosure, etc.), it is to be understood that, alternative embodiments can be easily envisioned to operate as an application running on a smart handheld device (SHD) such as a smartphone, other personal mobile devices, etc. Similarly, a device that includes both functionality of TABS device (370) and PAD device (310) may allow additional PAD devices (310) to avail themselves of the TABS services. Consider the circumstances where a school bus driver (not shown), at least one educator (301), and chaperones are on the same vehicle. Each is performing a different role, potentially having different authorities and responsibilities. As such, at hoc groups may be determined to assist in the case a crisis/emergency event occurs.

Once the PAD device (310) is operatively coupled to at least one of the TABS devices (370-373), upon the determination that a crisis or emergency event is occurring, the TABS device establishes communications with the at least one Crisis/Emergency Service responders (390, 392, 394, 396) such as Administrators, EMS, Fire, or Police personnel. Determination of the crisis or emergency event may be invoked manually by an individual such as an educator (301) at the touch of a button on the PAD device (310), or automatically by sensor logic operatively coupled to PAD device (310). For instance, in one illustrative embodiment, either PAD device (310) or TABS device (370) that is located within the school bus (330) may be equipped with an accelerometer. If the operatively coupled accelerometer detects a harsh stop/deceleration event, this could indicate that an accident has occurred. Other sensor information could also be communicated, potentially by coupling the TABS device (370) to an available vehicle bus interconnect. Information such as velocity, collision avoidance/awareness system information, audio, video, toxic substance detection, may potentially be made available to crisis/emergency management personnel enroute to the situation at hand.

In another exemplary embodiment, as aforementioned, the PAD device (310) and the TABS devices (370-373) can provide other critical information such as location of any asset that the devices are affixed to. Location coordinates may be derived from at least one of a multitude of sources including but not limited to: GNSS, Indoor Positioning System (IPS), Signal Strength of the communications medium, Triangulation, and Trilateration.

This essential information could potentially be provided to the at least one Crisis/Emergency services personnel, to further assist in dispatching assistance to the indicated event.

In another exemplary embodiment, the Teacher Alert System Services (382) (TASS) may be used to facilitate command, control, monitoring, and event distribution of the at least one Teacher Alert System (300). For instance some school districts may want to deploy a Teacher Alert System (300) district wide and have individuals migrate between facilities. In such an environment, the district may want to privately operate a network-based command and control center allowing for the centralized management of the Teacher Alert System technology under the total control of the district's information technology personnel. In this environment, the organization would take on the responsibility of operatively coupling the at least one TABS system with their instance of the TASS and the internal and external Crisis/Emergency Services. In other exemplary embodiments, for smaller and/or individual consumers, they may want to avail themselves of a centralized Internet (cloud) based TASS service (382) operated and maintained by a third party. In such environments, operations and maintenance of the TASS services and communication interconnects with crisis/emergency services (390, 392, 394, 396) are handled by a third party. In yet another embodiment, the TASS technology can be envisioned to operate as an application running on a SHD such as a smartphone, other personal mobile devices, etc., potentially combining the TASS, TABS, and/or PAD functionality, or any combination thereof, in a single device, mitigating the need for additional infrastructure components.

Now referring to FIG. 4. This schematic block diagram depicts a non-limiting exemplary embodiment of the Teacher Personal Alert Device (400). This purpose built, potentially a wearable pendent, wristband, or key fob device, is tailored for an educational environment. In this exemplary embodiment, the PAD device (400) includes, but not limited to:
A standard microprocessor architecture (410)
Individual function buttons (420, 422, 424, 426)
A wireless transceiver (430)
A power source—either battery (440) or external (442)
An audio/video input and output device (450)
A light emitting diode (LED) for operational indicia (460)
A power switch (470)

The controller device (410) or central processing unit may be combined with other components such as the memory, storage, wireless transceiver, and/or the audio interface as a single component known as a System-On-Chip device. Alternatively, controller device (410) may be composed on discrete components depending on the architecture and form factor of PAD unit (400).

The individual functional buttons (420-426) are exposed as part of the user interface for PAD device (400). Assuming that there is a sufficient power source (440, 442) to cause PAD device (400) to become operational, a user of the PAD device (400) when a crisis/emergency event occurs, would pressed the desired functional button for the requested emergency service. Providing single touch access, on a device that is located in proximity of the individual, saves valuable time, and mitigates any potential confusion that may occur when trying to locate the emergency contact information and establish communications with the at least one desired crisis/emergency management service. Each of the at least one functional buttons on PAD device (400) are preconfigured to establish communications with a specific service or individual.

For instance, in this non-limiting exemplary embodiment, button (426) is denoted as being linked to the particular school organization that the user is associated with. When button (426) is pressed, PAD device (400) begins the process of establishing communications with the at least one authorized individual within the school organization over wireless transceiver (430). Similarly, functional buttons for 911 (420), Police/Fire (422) and/or EMS (424) could be pressed, requesting service from other pre-determined crisis/emergency management services. Once operatively coupled to the authorized individuals, full duplex communications can commence. Depending on the configuration, upon acceptance of the call, a pre-recorded and/or potentially computer generated message may be played to the recipient of the call indicating that the communications is originating from PAD device (400) as well as potentially providing other salient information about the event, such as, but not limited to: Who PAD device (400) is associated with, Where the device is, and Any other information collected about the event. For instance in one non-limiting exemplary embodiment, one of the buttons could be configured for a specific type of incident such as an active shooter. Due to the significance assigned to the button or control, certain non-limiting embodiments may choose to protect the use of this functionality with a cover or other administrative policy such as a requiring a double press to invoke the functionality associated with it, minimizing any inadvertent or errant use. In other illustrative embodiments, at least one biometric marker sensor (e.g. fingerprint reader(s), EKG, iris, facial and/or voice recognition, etc.—not shown) may be used to allow only authorized individuals to invoke at least one specific function of PAD device (400).

In this exemplary embodiment, PAD device (400) could initiate a call to the same service as another button, but provide additional information detailing the type of event that is occurring. It is to be generally appreciated, that since this information is either computer generated and/or prerecorded, it can be better understood by the recipient, due to the fact that there are no distractions, background noise is eliminated, removes any human inflection in the communiqué, etc. and can be prepended or intermixed with the streamed audio/video/textual feed. Additional augmented information may also be displayed, translated, or interspersed into the communications stream that can be collected by the audio input or other potential sensor interfaces (not shown) that may be operatively coupled to PAD device (400). For instance, audio recognition software may be operating to determine the sound of a gunshot. In the event that audio signal processing logic detects the signature of a gunshot, PAD device (400) logic may indicate without human interaction to the at least one recipient via any in-band or out-of-band means (in-band messaging, SMS, audio indication, etc.) that such an event potentially took place.

Similarly, it's possible that PAD device (400) could capture heart rate information from an ailing individual from the audio input interface (450) or an operatively coupled EKG sensor. In another exemplary operating environment, PAD device (400) button (424) may be pressed to summon Emergency Medical Services personnel to the event. PAD device (400) along with the EKG sensor could provide vital life signal information in advance of the EMS personnel arriving on scene. Armed with the EKG information and potential credentials of the individual associated with PAD device (400), the EMS personnel in communications with PAD device (400) may instruct that CPR be administered to the person being monitored.

It is to be appreciated by those skilled in the art, it is easily envisioned that a plurality of sensor data could be captured and provided to the individuals/organizations responding to the crisis/emergency event.

In yet another non-limiting illustrative environment, a squelch function (not shown) may also be included as part of PAD device's (400) capabilities. It is to be appreciated that under certain circumstances, covert communications may be necessary. In such a non-limiting illustrative environment, the individual associated with PAD device (400) may not be able to communicate under threat of life or limb (e.g. active shooter, kidnapping, sexual assault, etc.). In such environments, the at least one recipient of the communications would still be able to surreptitiously monitor the occurring event, without alerting the at least one nefarious party that PAD device (400) is operatively communicating with at least one crisis/emergency service. Furthermore, when operating in such a covert mode of operation, it may also be necessary to signal at least one other PAD device (400A—not shown) that is in proximity to PAD device (400) and that PAD device (400A) should or must operate in a similar covert fashion, thus not potentially warning the at least one nefarious party that the at least one crisis/emergency management service has been contacted. Through intercommunications of TABS device(s) (370-373) and/or potentially the TASS service (382), along with location information provide by the at least two PAD devices (400, 400A), the determined set of at least 2 PAD devices (400, 400A) will then individually operate in a covert fashion until the event is over or other policy or control dictates that covert operation is no longer necessary, such as PAD device (400A) no longer being in proximity to PAD device (400).

As depicted in FIG. 4 non-limiting embodiment, PAD device (400) is also equipped with at least one light emitting diode (LED) (460) and a power switch (470). The power switch is conventionally used to control power to control unit (410). In one non-limiting exemplary embodiment, if switch (470) is in the off position, LED (460) is not illuminated. If switch (470) is moved to the on position, and assuming is being provided from battery source (440) or external source (442), controller (410) will initialize the environment and cause the PAD device (400) to become operational awaiting user input. In one exemplary embodiment, during the initialization phase, LED (460) may flash at different rates to indicate different phases of the initialization. Once the PAD device (400) is operatively coupled with an associated Teacher Alert Base Station device, the LED may glow a solid green. In yet another exemplary embodiment, if the battery power source dips below a certain threshold, LED (460) may glow red, indicating that it needs to be recharged. It is easily envisioned by those schooled in the art, that other patterns of device state annunciation can be indicated using the at least one LED (460) or other user interface mechanisms. In the exemplary embodiment where covert communications may be required, no visible or audible indications may be displayed/generated that the unit is operatively coupled to the at least one crisis/emergency service.

Now referring to FIG. 5. This schematic block diagram depicts a non-limiting exemplary embodiment of the Teacher Alert Base Station (500) (TABS). This purpose built or mobile SHD device, is an extensible communications platform used to interconnect PAD devices (400) as depicted in FIG. 3 & FIG. 4 with Internet and PSTN network base communication services. In this exemplary embodiment, the TABS device (500) includes, but not limited to:
A standard microprocessor architecture (510)
Internal and external sensor interface (520)
A power source—battery/external (522) with optional power/reset button (not shown)
Memory (524)
Storage (526)
User interface (530) with optional components:
   A display device (532)
   Input device interface such as keyboard, mouse, buttons, etc. (534)
   Audio input and output interface (536)
At least one communications interface (540)

The controller device (510) or central processing unit may be combined with other components such as the memory (524), storage (526), at least one communications interface (540), and/or an audio/video interface (536) as a single component known as a System-On-Chip device. Alternatively, controller device (510) may be composed of discrete components depending on the architecture and form factor of TABS unit (500).

The exemplary non-limiting embodiment of TABS unit (500) of FIG. 5 depicts the communications interfaces (540) may include, but not limited to:
Terrestrial Wireless Local Area Network (WLAN) technology (541)
Terrestrial Wireless Personal Area Network (WPAN) or Near Field Communications (NFC) technology (542)
Terrestrial Wireless Wide Area Network (WWAN) technology (543)
Extraterrestrial or Satellite network technology (544)
Terrestrial Wide Area Network (WAN) technology (545)
Terrestrial Public Switched Telephone Network (PSTN) technology (546)
Terrestrial Personal Area Network (PAN) technology (547)
Terrestrial Local Area Network (LAN) technology (548)
Other broadcast, multicast, or point to point voice communications technologies (549)

Assuming that there is a sufficient power source (522) to cause TABS unit (500) to become operational, the unit initializes its environment and becomes operatively coupled with data communication services via the at least one configured network interface(s) (540). Over the configured network channels, at least one configured PAD device (400) of FIG. 4 becomes operatively coupled with TABS unit (500) assuming its within the range limitations of the at least one communication interface(s) (540). If no PAD device (400) establishes communications with TABS unit (500), it loops awaiting for an inbound communications from such a device.

In the exemplary embodiment of FIG. 5, upon receiving an indication that a crisis/emergency event is occurring from an operatively coupled PAD device (400), the TABS device (500), attempts to establish communications with the requested crisis/emergency management service of FIG. 3. (390, 392, 394, 396). Depending on the selected service and configuration, coupling to the service may happen over at least one of the communication interfaces (540). For instance, in one non-limiting illustrative embodiment, TABS device (500) is operatively coupled to LAN, WLAN, WWAN, PSTN, and Satellite network connections. Based on a given administrative policy, TABS device (500) attempts to establish connectivity to the indicated crisis/emergency management service (390-396) over the at least one selected network interfaces. If communications with the crisis/emergency management service (390-39) is unable to be attained due to physical, environmental, or administrative conditions, a different communications interface may be selected, and the attempt is tried again. Depending on the configuration of the TABS unit (500), this process may continue until the selected service is reached, or a retry limit is reached and an error is returned to PAD device (400).

However, if communications is established, information is relayed between PAD device (400) and the selected crisis/emergency management service (390-396). Ancillary information and meta-data about TABS unit (500) and the originating PAD device (400) may be provided, as outlined previously to the recipient of the communications, assuming communications capabilities allow for such information flow. Other administrative policy decisions can also be made depending on the network environment that the communications is flowing over. For instance, if the connection is operating over a high-bandwidth LAN interconnect (548), and PAD device (400) is provisioned to provide video and audio communications, and the selected crisis/emergency management service can accept such communication streams, such data may flow in both directions. If however the operative network interface between the TABS unit (500) and the selected crisis/emergency management service (390-396) is satellite (544) or PSTN (546) with voice only communications (i.e. no data signaling), only an audio feed is communicated from and potentially to PAD device (400).

In yet another embodiment where there are at least two operational TABS units (500), where one unit is operatively coupled to at least one network interface used for communications with at least one crisis/emergency management service(s) (390-396), and the other TABS unit (500A—not shown) is not so provisioned, and TABS unit (500) and TABS unit (500A) can communicate over at least one network interconnect, TABS unit (500A) may request and use TABS unit (500) connectivity to the selected crisis/emergency management service (390-396) for the purposes of reporting the crisis/emergency event. Thus TABS unit (500) can operate in a meshed network environment where connectivity to external network services is limited by physical, environmental, or administrative limitations. Other combinations of communications flows and limitations can be easily envisioned by those schooled in the art.

In yet another non-limiting embodiment, a TABS unit can also operate as a PAD device (400). In one illustrative embodiment, TABS unit (500) can potentially act as a hot backup to, or augment the capabilities of any operatively connected PAD device (400). In the case of a backup device, if during the event, the initiating PAD device (400) becomes inoperable for some reason (nefarious or otherwise), correctly provisioned TABS units (500) can either continue the established communication, albeit potentially from a different vantage point, or establish another connection if the initial session was prematurely terminated. Furthermore, using the optional input and sensor interface, additional information can augment the information that is being be provided by PAD device (400) to the selected crisis/emergency management service (390-396). For instance it may be cost prohibitive to design a toxic substance sensor into to each PAD device (400). Consider a laboratory environment, where TABS unit (500) can service multiple PAD devices (400), and can be operatively coupled to a smoke, carbon monoxide, or other toxic substance (i.e. methane/propane gas, etc.) detector. Based on signaling from the operatively coupled sensor, additional environmental information and situational awareness of the event can be supplied to the selected crisis/emergency management (390-396) responders, assisting them in tailoring their response to the event that is occurring.

Now referring to FIG. 6. This schematic block diagram depicts a non-limiting exemplary embodiment of a Teacher Alert System (600) employing the additional Teach Alert System Services (610) (TASS). The non-limiting illustrative network TASS services (610) of FIG. 6 are used in conjunction with one another to centrally manage and provide for the command/control of a plurality of deployed TABS units (630) and PAD devices (620). The TASS services (610) include, but are not limited to:
A network interface service (611)
A database and/or storage service (612)
A communications processing service (613)
An administrative interface (614)
A notification and messaging service (615)
A media flow and recording service (616)
   In this exemplary embodiment, the TASS services (600) may operate within individual or multiple virtual or hardware computational environments, combined as a single service, or any combination thereof.

In the exemplary embodiment illustrated in FIG. 6, the TASS services (600) are an optional component within the Teacher Alert System. Additionally, TASS services may be maintained and operated by an individual organization, or may be operated as a multi-tenant cloud based service for a plurality of organizations. The non-limiting illustrative services as depicted in FIG. 6 provide the following functionality.

Network Service (611) provides connectivity to at least one of a plurality of terrestrial and extraterrestrial network interconnects. First and foremost it provides conventional administrative control (such as firewalling, load balancing, etc.) over network sessions between TABS units and the provided management/command and control services included in the TASS service (610). It may also act as a shunt service against nefarious or malicious attempts to thwart or malign the communications between TABS units (630) and crisis/emergency management services (650, 660, 670, 680). Additionally, it may participate in providing authorized access to an administrative web interface used for the management of deployed TABS units (630) and PAD devices (620).

Database and Storage Service (612) provides the backend data store services to record and manage the deployed TABS units (630) and PAD device (620). Other administrative constructs such as authentication credentials or policy settings may also be stored by the database services. The provided storage facilities may be used to maintain larger objects not suitable from inclusion in database tables such as firmware updates for purpose built TABS units (630) and PAD devices (620) or application updates for environments using SHD mobile/wearable devices.

The Communications Processing Service (613) is an intermediary endpoint for communications between TABS units (630) and provisioned crisis/emergency management services. In some deployments, access to PSTN or other network services may not be available directly to TABS units (630). In these cases, the TASS service (600) may aggregate access to the PSTN network infrastructure, allowing TABS units to operate in purely data networking environments. In other non-limiting embodiments, the Communications Processing Service (613) may act as the relay between differing network technologies such as satellite infrastructure and terrestrial base networks. This is due to the fact that some extraterrestrial networks require an authorized endpoint to send traffic to and receive traffic from their infrastructure. Furthermore, many of the local crisis/emergency management services (650-680) may not have an authorized endpoint to establish communications with the extraterrestrial infrastructure, thus requiring the TASS Communications Processing Service (613) to operate on their behalf.

Furthermore, based on administrative policy settings, the Communications Processing Service (613) can also act as a bifurcation point for communications flowing to or from deployed TABS units (630). For instance in one illustrative embodiment, if a crisis/emergency event is transpiring, administrative policy may dictate that not only is communications established with the selected crisis/emergency management service (650-670), a secondary authorized service such as the school administrator (680) be also notified that the event is occurring. Depending on the policy, Communication Processing Service (613) may act as a communications bridge, allowing all endpoints to communicate with one another based on the capabilities of each endpoint. Similarly, it may limit some participants in the bridged connection to only viewing/listening of the stream to mitigate any disruption of communication between the primary endpoints of the established session. In yet another illustrative embodiment, administrative policy may also dictate that other TABS units (630) and PAD devices (620) assigned to a group, be alerted to the fact that the event is transpiring. For instance in the event of nefarious individual such as an active shooter being on the campus of a school, alerting other staff to their presence is paramount to protecting other individuals within the confines of the facility. Notifications may also be delivered in a plurality of ways, including but not limited to text messaging, audio/visual alerts, emails, telephone calls, etc. Again additional ancillary information can be provided in the alert process, gathered from metadata and optional sensor input. Other scenarios utilizing the Communications Processing Service (613) as the traffic cop for active Teacher Alert System communications can be easily envisioned by those schooled in the art without departing from the spirit of the disclosed information.

In the illustrative embodiment of FIG. 6 the TASS web accessible Administrative Services (614) provides authorized administrative personnel a portal to manage and configure the TASS system service (610). It may also provide authorized individuals a portal to manage and control deployed TABS units (630) and PAD devices (620). If the TASS web accessible Administrative Service (614) is operating in multi-tenant mode, authorized individuals may be limited to the management and control of TABS units (630) and PAD devices (620) deployed within their domain. Other management embodiments can be easily envisioned such as a command line interface, or via an accessible Application Programming Interface (API) can be easily envisioned by those schooled in the art.

In the illustrative embodiment of FIG. 6 the TASS Notification and Messaging Service (615) provides for the interconnect between other TASS system services (611, 612, 613, 614, 616) and external messaging services such as SMS, email, voicemail, etc. In the event that a notification has to be forward via an external notification/messaging service, the TASS Notification and Messaging Service (615) provides the necessary glue logic to forward the communiqué to the intended at least one recipient via at least one notification methodology. Events such as component failures or errors, along with aforementioned crisis/emergency event notifications may be distributed via this service.

In the illustrative embodiment of FIG. 6, the TASS Media Flow and Recording Service (616) provide the ability for the TASS service to manipulate established audio/video communications between PAD devices (620) and crisis/emergency management service (650-680). Based on either endpoint limitations or administrative controls, resampling of the content stream may need to occur. For instance an audio stream may originate in a particular codec format that is not consumable by the peer endpoint. Codec translation of the audio/video streams may be necessary to ensure operative communications between the endpoints. Alternatively, it's quite possible in the aforementioned bridged communications session, one of the authorized parties may only be able to receive audio content. Consider an illustrative case of a police command center, a school administration official, police officers enroute to the scene, and the educator dealing with the crisis/emergency event. In this illustrative case the police command center, the school administration official, and the educator can process both the audio and video feeds. However the police officers enroute can only receive the audio stream on their handle devices. Instead of all participants of the bridged session having to drop to the least common denominator, the non-limiting embodiment of the TASS Media Flow and Recording Service (616) of FIG. 6 strips out the video content and repackages the audio stream for delivery to the police officers' handheld devices.

In another non-limiting exemplary embodiment, the TASS Media Flow and Recording Service (616) provides the ability to record the established communications session for historical purposes, should the information be needed for evidentiary purposes.

It will be readily understood by those schooled in the art that the present invention enables additional advantage that may be realized by an organization or customer, as they can now avail themselves of the aggregated services offered by the TASS Services (610), providing them access to solutions not previously available with increased economies of scale. Without these advantages set forth, the total cost of replicating these services by a customer or organization may be cost prohibitive, potentially putting an organization or customer at risk.

Those of skill would further appreciate that the various illustrative logical blocks, modules, circuits, and algorithm steps described in connection with the embodiments disclosed herein may be implemented as electronic hardware, computer software running on a specific purpose machine that is programmed to carry out the operations described in this application, or combinations of both. To clearly illustrate this interchangeability of hardware and software, various illustrative components, blocks, modules, circuits, and steps or actions have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the exemplary embodiments.

The various illustrative logical blocks, modules, and circuits described in connection with the embodiments disclosed herein, may be implemented or performed with a general or specific purpose processor, or with hardware that carries out these functions, e.g., a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A general-purpose processor may be a microprocessor (small-size-processor), but in the alternative, the processor may be any conventional processor, controller, microcontroller, or state machine. The processor can be part of a computer system that also has an internal bus connecting to cards or other hardware, running based on a system BIOS or equivalent that contains startup and boot software, system memory which provides temporary storage for an operating system, drivers for the hardware and for application programs, one or more trigger or interface which provides an interface between system elements and the other hardware, at least one external peripheral controller which interfaces to external devices such as a backup storage device, power management, communicator protocol management, and one or more networks and interface(s) that connect to a hard wired transmitters (e.g., RF transmitters) or network cable such as Ethernet or may be a wireless connection such as a RF link running under a wireless protocol such as 802.11. Likewise, an external bus may be any of but not limited to hard wired external busses such as IEEE-1394 or USB. The computer system can also have a user interface port that communicates with a user interface, and which receives commands entered by a user by voice, by touch, or by motion recognition, and an output that produces its output via any kind of output format, e.g., signal trip, cellular protocol, RF protocols, VGA, DVI, HDMI, display port, or any other form. Such systems may include laptop or desktop computers, and may also include portable computers, computer relays, smart (IoT) interface components, including wall sensors, personal-alert devices with one or more communication triggers, cell phones, tablets such as the IPAD™ and Android™ platform tablet, and all other kinds of computers and computing platforms.

A processor may also be implemented as a combination of computing devices, e.g., a combination of a DSP and a microprocessor, a plurality of microprocessors, one or more microprocessors in conjunction with a DSP core, or any other such configuration. These devices may also be used to select values for devices as described herein.

The steps of a method or algorithm described in connection with the embodiments disclosed herein may be embodied directly in hardware, in a software module executed by a processor, using cloud computing, or in combinations. A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD-ROM, or any other form of tangible storage medium that stores tangible, non-transitory computer based instructions. An exemplary storage medium is coupled to the processor such that the processor can read information from, and write information to, the storage medium. In the alternative, the storage medium may be integral to the processor. The processor and the storage medium may reside in reconfigurable logic of any type.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer.

The memory storage can also be of any suitable memory technological solution, including flash memory based storage drives or other such solid state, magnetic, or optical storage devices. Also, any connection is termed a computer-readable medium. For example, if the software or signal indication is transmitted from a website, server, or other remote source via a communication protocol, using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium.

The computers described herein may be any kind of computer or computer device or computerized device, either general purpose, or some specific purpose computer such as a smart relay, IoT node, personal trigger-fob, a workstation, etc. The programs may be resident on a storage medium, e.g., magnetic or optical, e.g. the computer hard drive, a removable disk or media such as a memory stick or SD media, or other removable medium. The programs may also be run over a network, for example, with a server or other machine sending signals to the local machine, which allows the local machine to carry out the operations described herein.

Also, the inventors intend that only those claims which use the words “means for” are intended to be interpreted under 35 USC 112, sixth paragraph. Moreover, no limitations from the specification are intended to be read into any claims, unless those limitations are expressly included in the claims.

It will be readily understood by those persons skilled in the art that the present invention is susceptible to broad utility and application. Many embodiments and adaptations of the present invention other than those herein described, as well as many variations, modifications and equivalent arrangements, will be apparent from or reasonably suggested by the present invention and foregoing description thereof, without departing from the substance or scope of the invention.

While the foregoing illustrates and describes exemplary embodiments of this invention, it is to be understood that the invention is not limited to the construction disclosed herein. The invention can be embodied in other specific forms without departing from its spirit or essential attributes.

What is claimed is:

1. An apparatus, for establishing a communication link with at least one crisis/emergency management service via a mobile personal alert device associated with an asset, the mobile personal alert device, comprising:
a processor disposed and structured to receive inputs from at least one functional button that when pressed initiates the establishment communications between the personal alert device and the at least one selected crisis/emergency management service;
at least one operatively coupled network interface used for the establishment of said communications link;
at least one operatively coupled input device that is capable of capturing at least one of audio, video, and other data for subsequent transmittal to the at least one crisis/emergency management service;
at least one operatively coupled output device that is capable of rendering a received at least one of audio, video, and other data for consumption by the associated asset;
a non-transitory memory device storing instructions that when executed by the processor causes the detection of the at least one pressed button signifying that a crisis/emergency event is transpiring;
the detection of the pressed button further causes the establishment of the aforesaid communications over at the least one operatively coupled network interface;
the non-transitory memory device stores further instructions that when executed by the processor causes at least one of audio, video, and other data to be communicated between the personal alert device and the at least one crisis/emergency management service; and
wherein the reception of at least one of audio, video, and other data enables the at least one recipient of the communications at the at least one crisis/emergency management service to enact policies and procedures that assist the asset associated with the personal alert device in dealing with the transpiring crisis/emergency event.

2. The apparatus of claim 1 wherein: the non-transitory memory device store further instructions that when executed by the processor of the personal alert device causes any of the at least one of audio, video, and other data received from the at least one crisis/emergency management service to be output for consumption by the associated asset; and
wherein the at least one output of audio, video, and other data provides information to the asset associated with the personal alert device regarding the crisis/emergency event that is transpiring.

3. The apparatus of claim 2 wherein the information provided by the at least one output of audio, video, and other data provides guidance to the asset as to when assistance will arrive.

4. The apparatus of claim 1 wherein the other data that is transmitted to the at least one crisis/emergency management service is captured by at least one operatively coupled sensor device.

5. The other data of claim 4 that is captured by the at least one operatively coupled sensor comprises location information of the personal alert device.

6. The other data of claim 4 that is captured by the at least one operatively coupled sensor comprises surrounding environmental information in proximity to where the personal alert device is located.

7. The apparatus of claim 1 wherein the other data that is transmitted to the at least one crisis/emergency management service is preconfigured.

8. The other data of claim 7 that is preconfigured comprises information regarding the asset associated with the personal alert device.

9. The other data of claim 7 that is preconfigured alerts the recipient of the communications at the at least one crisis/emergency management service that the personal alert device is operating in a covert mode.

10. In a distributed computing environment, a method for enabling the simplified establishment of prioritized communications between a Personal Alert Device (PAD) associated with an asset and at least one selected Crisis/Emergency Management Service (CEMS) during a crisis/emergency event, the method comprising the steps of:
a determination that a crisis/emergency event is transpiring;
the determination causing the establishment of a first communication link between a PAD and a communications interface aggregation facility (CIAF) over a first operatively coupled network interface;
the establishment of the first communications link causing the CIAF to establish a second communications link between the CIAF and the at least one selected CEMS over an operatively coupled at least one of a terrestrial and extraterrestrial communications interface;
wherein the CIAF acts as a relay for communications between the PAD and the at least one selected CEMS; and
wherein the established first and second communication links provides a pathway for the exchange at least one of audio, video, or other data between the PAD, the CAIF, and the at least one selected CEMS.

11. The method of claim 10 wherein the determination that a crisis/emergency event is transpiring is manually invoked by the press of a button on the PAD.

12. The method of claim 10 wherein the determination that a crisis/emergency event is transpiring is automatically invoked by the PAD due to an operatively coupled sensor detecting that an environmental factor has surpassed a given threshold.

13. The method of claim 10 wherein any of the at least one of audio, video, and other data received from the at least one CEMS to be output by the PAD device for consumption by the asset associated with the PAD provides information to the asset regarding the crisis/emergency event that is transpiring.

14. The method of claim 13 wherein the other data that is captured by the at least one operatively coupled sensor comprises location information of the PAD.

15. The method of claim 13 wherein the other data that is captured by the at least one operatively coupled sensor comprises surrounding environmental information in proximity to where the PAD is located.

16. The method of claim 10 wherein the other data that is transmitted to the at least one CEMS is preconfigured.

17. The method of claim 16 wherein the other data that is preconfigured comprises information regarding the asset associated with the personal alert device.

18. The method of claim 16 wherein the other data that is preconfigured comprises information regarding other individuals associated with the asset of claim 24.

19. The method of claim 16 wherein the other data that is preconfigured alerts the recipient of the communications at the at least one crisis/emergency management service that the personal alert device is operating in a covert mode.

20. The method of claim 10 wherein the other data that is transmitted to the at least one CEMS is computer generated.

21. In a distributed computing environment, a method for enabling the simplified establishment of prioritized communications between a Personal Alert Device (PAD) associated with an asset and at least one selected Crisis/Emergency Management Service (CEMS) during a crisis/emergency event, the method a comprising the steps of:
a determination that a crisis/emergency event is transpiring;
the determination causing the establishment of a first communication link between a PAD and a communications interface aggregation facility (CIAF) over a first operatively coupled network interface,
the establishment of the first communications link causing the CIAF to establish a second communications link between the CIAF and an Alert System Management Service (ASMS) over an operatively coupled at least one of a terrestrial and extraterrestrial communications interface;
the establishment of the second communications link causing the ASMS to establish a tertiary communications link between the ASMS and at least one of the selected CEMS over an operatively coupled at least one of a terrestrial and extraterrestrial communications interface;
wherein the CIAF and the ASMS acts as relays for communications between the PAD and the at least one selected CEMS;
wherein the established first, second, and tertiary communication links provides a pathway for the exchange at least one of audio, video, or other data between the PAD, the CAIF, the ASMS, and the at least one selected CEMS.

22. The method of claim 21 wherein the determination that a crisis/emergency event is transpiring is manually invoked by the press of a button on the PAD.

23. The method of claim 21 wherein the determination that a crisis/emergency event is transpiring is automatically invoked by the PAD due to an operatively coupled sensor detecting that an environmental factor has surpassed a given threshold.

24. The method of claim 21 wherein the determination that a crisis/emergency event is transpiring is automatically invoked by the PAD due to an operatively coupled sensor detecting that the signature of a particular action has occurred.

25. The method of claim 21 wherein the reception of at the least one of audio, video, and other data enables the at least one recipient of the communications at the at least one CEMS to enact policies and procedures that assist the asset associated with the PAD in dealing with the transpiring crisis/emergency event.

26. The method of claim 21 wherein any of the at least one of audio, video, and other data received from the at least one CEMS to be output by the PAD device for consumption by the asset associated with the PAD provides information to the asset regarding the crisis/emergency event that is transpiring.

27. The method of claim 26 wherein the information provided by the at least one output of audio, video, and other data provides guidance to the asset associated with the PAD as to when assistance will arrive.

28. The method of claim 21 wherein the other data that is transmitted to the at least one CEMS is preconfigured.

29. The method of claim 28 wherein the other data that is preconfigured comprises information regarding the asset associated with the personal alert device.

30. The method of claim 28 wherein the other data that is preconfigured comprises information regarding the organization associated with the personal alert device.

31. The method of claim 28 wherein the other data that is preconfigured comprises information regarding the area where the personal alert device in located.

32. The method of claim 28 wherein the other data that is preconfigured comprises information regarding other individuals associated with the asset of claim 24.

33. The method of claim 28 wherein the other data that is preconfigured alerts the recipient of the communications at the at least one crisis/emergency management service that the personal alert device is operating in a covert mode.

34. The method of claim 21 wherein the other data that is transmitted to the at least one CEMS is computer generated.

35. The method of claim 21 wherein the ASMS acts as a communication bridge and bifurcates the communications of the at least one of audio, video, or other data exchanged between the PAD, the at least one selected CEMS, and with at least one other CEMS based on policy settings established for the organization associated with the PAD.

36. The method of claim 21 wherein the ASMS acts as a translator for the communications of at the least one of audio, video, or other data exchanged between the PAD and the at least one CEMS based on capabilities of each endpoint of the communications.

37. The method of claim 35 wherein the ASMS acts as a translator for the communications of at the least one of audio, video, or other data exchanged between the PAD and the at least one CEMS based on capabilities of each endpoint of the communications.

38. A teacher alert system, comprising:
at least one personal alert device in operable communication with at least one base station located remotely from said at least one personal alert device;
said at least one personal alert device comprising at least one button to cause at least one response and/or action;
said at least one button being an active shooter button that is recessed, and actuation of said active shooter button causes actions that includes at least one said operable communication with said at least one base station;
said at least one base station in operable communication with said at least one personal alert device, said at least one base station comprising:
a microphone and the ability to produce audio signals from the ambient;
a said speaker and the ability to produce audible sound;
a display screen capable of displaying visual images including text or a touch screen capable of displaying visual images including text and sending user generated text;
the ability to make and receive cellular telephone calls;
the ability to send at least one prestored text message;
a system monitor interface in operable communication
said base station being effective to receive at least one communication from said at least one personal alert device wherein said system monitor interface recognizes a responder-call-signal from said at least one personal alert device and identifies said at least one personal alert device;
said at least one said operable communication causing said base station to cause at least one other communication and the squelching to prevent sound production from a speaker located in said at least one base station;
a responder call system in operable communication with said system monitor interface and at least one of an external responder protocol interface; and
a processor in said system monitor interface, upon receiving said responder-call-signal and identifying said at least one personal alert device, triggers and transmits a request to said responder call system and said external responder protocol interface.

39. The teacher alert system of claim 38 wherein said active shooter button additionally causes muting on all audio and/or noise producing components so said personal alert device remains silent.

40. The teacher alert system of claim 38 further comprising a prerecorded audio communication that states that an active shooter or life-threatening emergency is in progress and further states the location of said personal alert device and states that verbal communication is not possible due to the nature of the threat.

41. The teacher alert system of claim 38 further comprising a repeater network that can receive wireless signals from said at least one base station and transmit wireless signals to said at least one base station, said repeater network capable of causing extended range of coverage to encompass a plurality of said base station in locations where other network service may not be available.

42. The teacher alert system of claim 38 wherein said at least one button is an active shooter button that when pressed causes to be sent the location of said personal alert device to at least one of a police department, agency, administration, authority, and response team.

43. The apparatus of claim 1 wherein the other data that is transmitted to the at least one crisis/emergency management service is location information derived from network resources.

44. The apparatus of claim 1 wherein the functional button is a biometric marker sensor.

45. The apparatus of claim 1 wherein the authorization to invoke personal alert device functionality is granted in conjunction with a biometric marker sensor.

46. The apparatus of claim 1 wherein access to PAD functionality is invoked by predefined sequence of button operations.

47. The method of claim 10 wherein a first PAD and at least one other PAD is in operative communications with at least one CAIF;
the first PAD signals that a crisis/emergency event is transpiring;
the first PAD further signals that it is operating in a covert mode; and
the at least one other PAD device determines base on proximity to the first PAD device that it should also operate in a covert mode.

48. The method of claim 21 wherein a first PAD and at least one other PAD is in operative communications with at least one of a CAIF and ASMS;
the first PAD signals that a crisis/emergency event is transpiring;
the first PAD further signals that it is operating in a covert mode; and
the at least one other PAD device determines base on proximity to the first PAD device that it should also operate in a covert mode.
